(19) United States
(12) Patent Application Publication
(10) Pub. No.: US 2009/0282664 A1
(43) Pub. Date: Nov. 19, 2009

(54) METHOD FOR REPAIRING A FLIGHT COMPONENT AND PATCH THEREFOR

(75) Inventors: Dirk HOLZHUTER, Braunschweig (DE); Michael HANKE, Braunschweig (DE); Babett KUJAK, Braunschweig (DE)

Correspondence Address: HAHN LOESER & PARKS, LLP, One GOJO Plaza, Suite 300, AKRON, OH, 44311-1076, US

(73) Assignee: DEUTSCHES ZENTRUM FUR LUFTUND RAUMFAHRT E.V., Koln (DE)

(21) Appl. No.: 12/433,376

(22) Filed: Apr. 30, 2009

(30) Foreign Application Priority Data
Apr. 30, 2008 (DE) 10 2008 021 788.3

(51) Int. Cl. B23P 6/00

(52) U.S. Cl. 29/402.08

(57) ABSTRACT

The invention relates to a method for repairing an aircraft component (10) of fiber reinforced plastic, with the steps of: cutting out a damage site (12) by creating a hole (14), which (i) has a first extent (A₁) in a first direction and (ii) has a second extent (A₂), which is greater than the first extent (A₁), in a second direction, extending transversely in relation to the first direction, and (iii) has a scarfed rim (16), guiding through the hole (14) an inner patch (36), which is formed so as to cover the hole (14) completely from an inner side of the aircraft component (10), closing the hole (14) with a middle patch (26), which has a scarfed rim, the rim of the patch complementing the rim (16) of the hole, and adhesively bonding the patches (26, 36) to the aircraft component (10).

The invention relates to a method for repairing an aircraft component of fiber reinforced plastic. Such methods are used to repair damage sites in aircraft components. Fiber reinforced plastics, in particular carbon fiber reinforced plastics, are increasingly being used in the development of passenger aircraft. In new passenger aircraft, fiber reinforced plastics are also used in the wing shells and in the fuselage segments. Damage to the components of the aircraft, for example instances of delamination, may be caused, for example, by stone impact or by bird strikes. In cases of delamination, the bond between the fibers and the matrix in which the fibers are embedded is locally broken. Such damage sites must be repaired.

It is known to repair such damage sites by patches. A patch is understood as meaning a piece of material that is attached to the location of the damage site. In the case of such a repair, the damage site is cut out and the patch is adhesively fixed or riveted onto the damage site. Modern passenger aircraft are complex machines in which sometimes it is only with great difficulty that the damaged aircraft component can be accessed from both sides, namely from the outside and from the inside. For this reason, repairs can often only be carried out as part of more major maintenance measures. As a result, there may be the possibility of existing damage continuing to cause trouble.

A method for repairing an aircraft component is known from U.S. Department of Transportation, Federal Aviation Administration: “Acceptable Methods, Techniques, and Practices—Aircraft Inspection and Repair”. Advisory Circular No 43.13-1B, Oklahoma City: Sep. 8, 1998, Chapter 3, Section 1-4. A disadvantage of this is that the method is complicated and time-consuming.

The invention is based on the problem of providing a method for repairing an aircraft component of fiber reinforced plastic that can be carried out particularly easily and inexpensively.

The invention solves the problem by a method according to claim 1. According to a second aspect, the invention solves the problem by a patch kit.

An advantage of the method according to the invention is that it can be carried out particularly quickly. This applies in particular whenever the damage site is on an aircraft component that is only easily accessible from the outside. A further advantage is that the method according to the invention has particularly little influence on the stability of the aircraft component.

It is also advantageous that the method can be carried out with little equipment. For example, there is no need for vacuum devices. As a result, the method can also be carried out by personnel who do not have to be trained as intensively.

In the present description, an aircraft component is understood in particular as meaning any component of a passenger aircraft that is accessible from the outside.

The feature that the hole has a scarfed rim is understood in particular as meaning that the material thickness of the aircraft component increases with increasing distance from an interior of the hole. It is favorable if the rim of the hole extends in a straight-sloping manner. This means that the material thickness of the aircraft component increases linearly with increasing distance from the interior of the hole.

The locational indications “inner” and “outer” relate to the corresponding position in the aircraft to which the component that is being repaired belongs. In particular, the method therefore also concerns a method for repairing an aircraft.

In a preferred embodiment, the method comprises the steps of placing on an outer patch and adhesively bonding the outer patch to the aircraft component. The middle patch is then arranged in particular between the inner patch and the outer patch and can likewise be adhesively bonded to them. An advantage of this is that the middle patch is protected by the inner patch and the outer patch and particularly great strength of the repaired aircraft component is obtained.

A method which can be carried out particularly easily, inexpensively and quickly is obtained if all the patches have openings which are arranged in such a way that, when the hole is closed with the patches, the openings form a through-opening and if a tool which reaches through at least some of the openings is used for guiding through the inner patch and for placing on the middle patch. In particular, the tool is also used for holding the outer patch. In other words, preferably all the patches are held by the tool. In this way, the method can be carried out particularly quickly and reliably.

The tool is preferably used to press or pull the inner patch against the aircraft component during the adhesive bonding. For this purpose, the tool may have a hook or a projection, so that a force can be applied to the inner patch with the tool. It is then possible to provide the inner patch with adhesive and to use the tool to pull it against the aircraft component from an inner side of the aircraft component until the adhesive holds the patch. In this way, a particularly strong and secure adhesive bond is obtained.

According to a preferred embodiment, the method according to the invention comprises the steps of ascertaining a damage site location of the damage site, determining a contour of the aircraft component in an area around the damage site and creating the patches in such a way that they follow the contour of the aircraft component. Such components often have a single or double curvature. For example, aircraft components are locally convex. In order that this contour is disturbed as little as possible by the repair of the aircraft component, this contour of the aircraft component is taken up in such a way that the patches are produced so as to follow the contour of the aircraft component. This should be understood as meaning that the patches are formed in such a way that they coincide as exactly as possible to the contour of the aircraft component. In particular, the middle patch is formed in such a way that its insertion re-establishes the original structure of the aircraft component. It is unproblematic if, for example, the inner patch or the outer patch has a contour that deviates from the contour of the aircraft component.

The determination of the contour of the aircraft component preferably comprises scanning or taking an impression of the surface contour. The scanning may take place, for example, by optical or tactile means. For taking an impression of the surface contour, a curable casting compound may be used, for example. In this way, a particularly stable repaired aircraft component is obtained.

The determination of the structure of the aircraft component preferably comprises retrieving the surface contour from a databank on the basis of the damage site location. For this purpose, a center point of the damage location in relation to the aircraft may be measured, for example. Then the exact contour of the aircraft component is determined from a CAD data record kept in a databank and the corresponding patch, in particular the middle patch, is produced in such a way that it corresponds to the contour of the aircraft component. In this way, particularly stable repaired aircraft components are obtained.

The creation of the patches preferably comprises the steps of laying CRP prepregs (CRP, carbon fiber reinforced plastic) of various dimensions one on top of the other, adhesively bonding the CRP prepregs, in particular by heating, impregnating the CRP prepregs with resin and curing the impregnated CRP prepregs, so that the patch is produced. It is particularly favorable to wet the CRP prepregs with resin by vacuum impregnation.

The structure of the aircraft component is weakened particularly little by the repair if the fiber mats are laid one on top of the other in such a way that the directions of their fibers correspond to the directions of the fibers of the aircraft component to be repaired. For each aircraft component, it is known from the production of the aircraft component in which orientation the fiber mats were laid one on top of the other. It is particularly favorable if the patch, in particular the middle patch, is built up with the fibers running in the same directions. Moreover, the patch preferably has the same number of fiber mats as the aircraft component to be repaired. The sequence of the directions of the fibers is taken, for example, from a data bank.

The adhesive bonding of the CRP prepregs by heating takes place, for example, by the fiber mats being provided with thermoplastic particles, which melt during heating and in this way loosely bond together fiber mats lying against one another.

In order to reduce distortion of the fiber mats, it is preferably provided that the fiber mats are laid one on top of the other in a stack in such a way that the stack has a convex inward curving at the periphery and, during the adhesive bonding, at least two fiber mats that are not neighboring are bonded together. For example, initially fiber mats with decreasing dimensions are laid one on top of the other. Subsequently, fiber mats with again increasing dimensions are laid one on top of the other. In this way, fiber mats that are separated from one another by further fiber mats are bonded together and distortion is avoided.

The curing preferably comprises the steps of introducing the stack into a curing mold which corresponds to the contour of the aircraft component and curing the stack, so that the patch is produced. The curing mold is produced, for example, by the contour of the aircraft component being determined as described above. After that, the curing mold is produced by rapid prototyping, for example milled, on the basis of the contour of the aircraft component. One possibility is to mill out the curing mold from a block of aluminum. This operation can be carried out quickly, so that little time has to be spent on the repair of the aircraft component.

It is particularly advantageous if all the patches that are used for repairing the aircraft component are cured in a common curing device. For this purpose, a multi-part curing mold is used, between the submolds of which the individual patch blanks are arranged.

To carry out the method according to the invention, preferably a patch with a scarfed rim is used. It is advantageous if a patch kit that is formed in such a way that the hole can be closed is provided.

An exemplary embodiment of the method according to the invention is explained in more detail below with reference to the accompanying drawings, in which:

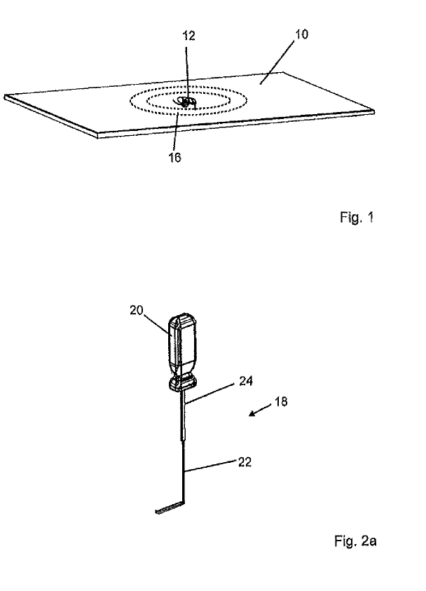

FIG. 1 schematically shows an aircraft component with a damage site and a hole to be introduced around the damage site,

FIG. 2a shows a tool for carrying out a method according to the invention,

FIG. 2b shows the tool according to FIG. 2 with an inner patch, a middle patch and an outer patch,

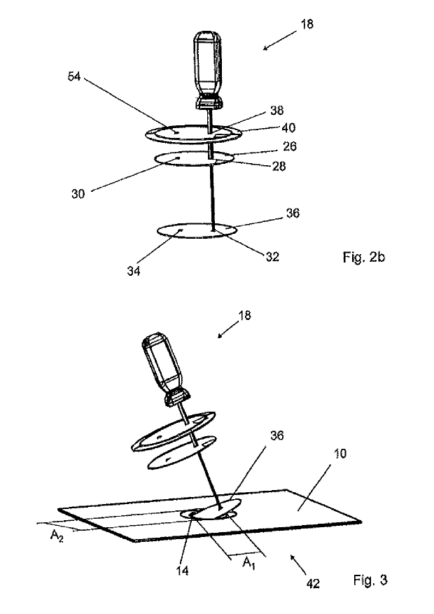

FIG. 3 shows the guiding of the inner patch through the hole,

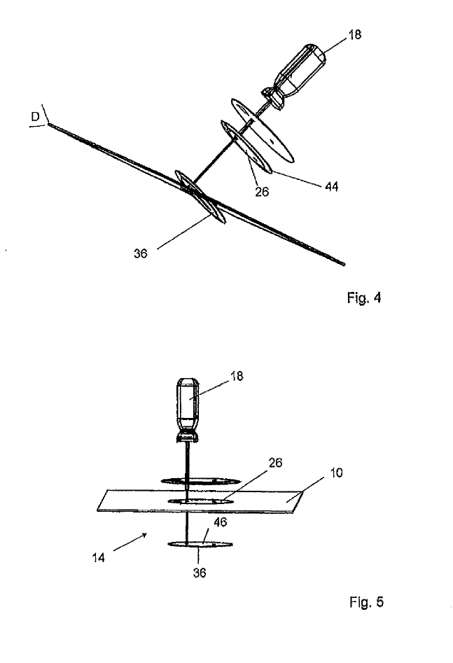

FIG. 4 shows the situation in FIG. 5 from a different perspective,

FIG. 5 shows the state in which the middle patch is adhesively bonded to the aircraft component,

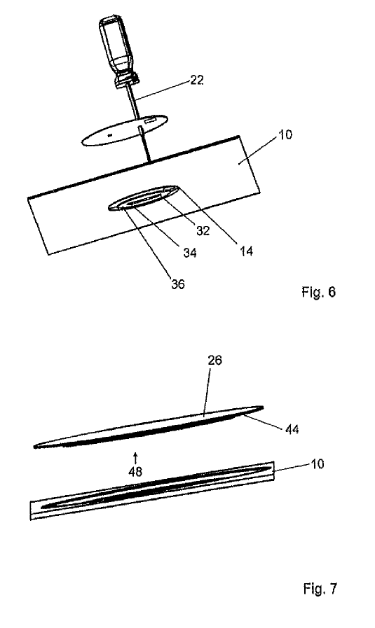

FIG. 6 shows a view of the aircraft component from below,

FIG. 7 shows a detail from FIG. 6,

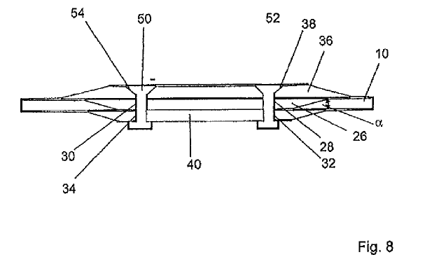

FIG. 8 shows a cross section through a repaired aircraft component,

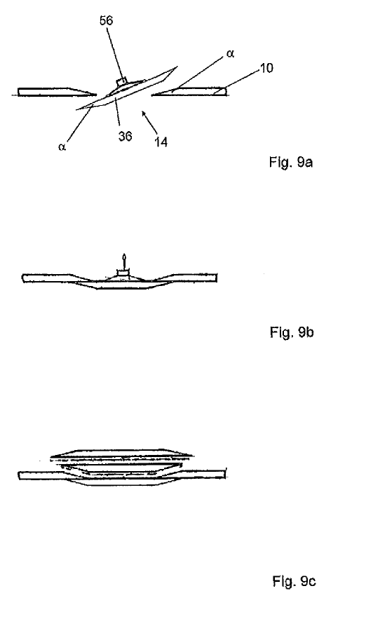

FIGS. 9a-9c show an alternative method according to the invention,

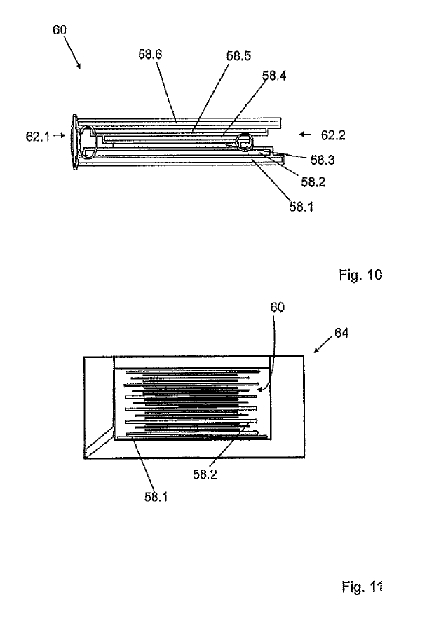

FIG. 10 shows a stack of fiber mats for producing a patch and

FIG. 11 shows a curing mold in a curing device.

FIG. 1 shows an aircraft component 10 with a damage site 12. The aircraft component 10 is part of an aircraft that is otherwise not depicted. The method described below may also be carried out when the aircraft component 10 is still in the aircraft.

In a first step, the damage site 12 is removed by cutting a schematically depicted hole 14 around the damage site 12. This is performed, for example, by CRP milling. The hole 14 has a rim 16, which is scarfed, that is to say goes over into the aircraft component 10 along a straight line. The rim of the hole is cleaned and prepared by shot peening or grinding for subsequent adhesive bonding, by an adhesive being applied.

FIG. 2a shows a tool 18, which has a handle 20 and a hook 22. The hook 22 is surrounded by a silicone tube 24 on a portion near the handle 20.

FIG. 2b shows the tool 18 with the hook 22 reaching through a middle patch 26 in a first opening 28. The middle patch 26 also has a second opening 30. The hook 22 also reaches through a first opening 32 and a second opening 34 of an inner patch 36 and through a first opening 38 of an outer patch 40. The inner patch 36 is held by the hook 22, the other patches 26, 40 are held by the silicone tube 24.

FIG. 3 shows how, using the tool 18, the inner patch 36 is guided through the scarfed hole 14, so that it arrives on an inner side 42 of the aircraft component 10. In the present case, the hole 14 is oval and has a first extent A₁ and a second, smaller extent A₂. In the present case, the hole 14 is convex, which however is not necessary.

FIG. 4 shows the situation according to FIG. 3 from a different perspective. It can be seen that the inner patch 36 has an extent that allows it to be pushed through the hole 14. It can also be seen that the middle patch 26 has a rim 44, which complements the rim 16 of the hole (cf. FIG. 1), so that a thickness of the middle patch 26 and of the aircraft component 10 add together to form a thickness D of the aircraft component 10 at every position of the respective rim.

FIG. 5 shows the situation where the middle patch 26 is resting with its rim exactly on the rim of the hole, so that the hole 14 is covered by the middle patch 26 with an exact fit. In this state, the middle patch 26 and the aircraft component 10 are adhesively bonded together. An epoxy-resin-based single-component adhesive may be used, for example, for this purpose. If necessary, for this purpose the middle patch 26 is pushed or pulled against the aircraft component 10. By means of fixing edges in the patch and in the hole, the patch is centered and prevented from slipping. The middle patch is therefore adhesively fixed first.

Possibly after a waiting time, the tool 18 is used to pull the inner patch 36 onto the aircraft component 10. The inner patch 36 is provided with adhesive 46 on a side facing the aircraft component 10.

FIG. 6 shows the state in which the inner patch 36 is adhesively bonded to the aircraft component 10 from the inside. If appropriate, the tool 18 is used to exert a tensile force with which the inner patch 36 is pressed against the aircraft component 10.

FIG. 7 shows a view of a detail of the aircraft component 10 and of the middle patch 26. It can be seen that the rim 44 of the patch is set back from a central region 48 and then tapers in the form of a wedge to a periphery of the middle patch. The central region 48 has exactly the dimensions of an interior of the hole 14. As a result, the middle patch 26 can be fitted into the hole 14 with a form fit.

FIG. 8 shows in a cross section the state in which the inner patch 36 has been adhesively fixed onto the aircraft component 10. A first rivet 50 and a second rivet 52 can also be seen, respectively reaching through the first openings 38, 28, 32 and the second openings 54, 30, 34, and so bracing the inner patch 36 against the outer patch 40. After the adhesive bonding of the outer patch 40 to the aircraft component 10, the rivets 50, 52 are driven through the respective openings. Once the adhesive has cured, the aircraft component 10 has been repaired.

Typical dimensions of the patches 26, 36, 40 are diameters of between 10 mm and 300 mm. In principle, however, larger diameters are also conceivable. The rim 16 of the hole and the rim 44 of the patch have a scarf angle α, which is generally greater than 2° and usually less than 10°. Angles of between 3° and 5° are particularly suitable.

FIGS. 9a to 9c show an alternative embodiment of a method according to the invention in which a suction cup 56 is used to move the inner patch 36 through the hole 14 and pull it against the aircraft component 10 during the adhesive bonding.

FIG. 10 shows a number of CRP prepregs in the form of fiber mats 58.1, . . . 58.6, the fiber mats being laid one on top of the other initially with decreasing dimensions (fiber mats 58.1, 58.2, 58.3) and then with again increasing dimensions (fiber mats 58.4 to 58.6).

In this way, a stack 60 that has convex inward curvings 62.1, 62.2 at both peripheries is obtained.

The fiber mats 58 are pressed together at their respective ends, so that, for example, the ends of the fiber mats 58.6 and 58.1 come into contact with one another. In this state, they are heated, so that they bond together on the basis of melting thermoplastics on the fiber mats.

In this state, the stack 60 is introduced into a vacuum chamber 64. The vacuum chamber 64 is evacuated and the fiber mats 58 are subsequently impregnated with a curable resin. In the impregnated state, the stack 60 is introduced into a mold that has the contour of the aircraft component 10. In a method known per se, the impregnated fiber mats are then bonded together to form the patch.

### LIST OF DESIGNATIONS

10 aircraft component
12 damage site
14 hole
16 rim of hole
18 tool
20 handle
22 hook
24 silicone tube
26 middle patch
28 first opening
30 second opening
32 first opening
36 inner patch
38 first opening
40 outer patch
42 inner side
44 rim of patch
46 adhesive
48 central region
50 rivet
52 rivet
54 second opening
56 suction cup
58 fiber mat
60 stack
62 inward curving
68 vacuum chamber
A extent
D thickness
α scarfing angle

1. A method for repairing an aircraft component (10) of fiber reinforced plastic comprising the steps of
(a) cutting out a damage site (12) by creating a hole (14), which
(i) has a first extent (A₁) in a first direction and
(ii) has a second extent (A₂), which is greater than the first extent (A₁), in a second direction, extending transversely in relation to the first direction, and
(iii) has a scarfed rim (16),
(b) guiding through the hole (14) an inner patch (36), which is formed so as to cover the hole (14) completely from an inner side of the aircraft component (10),
(c) closing the hole (14) with a middle patch (26), which has a scarfed rim, the rim of the patch complementing the rim (16) of the hole, and
(d) adhesively bonding the patches (26, 36) to the aircraft component (10).

2. The method according to claim 1, characterized by the steps of:
placing an outer patch (40) onto the middle patch (26), and
adhesively bonding the outer patch (40) to the aircraft component (10).

3. The method according to claim 1, characterized in that
the patches (26, 36, 40) have openings which are arranged in such a way that, when the hole (14) is closed with the patches (26, 36, 40), the openings form a through-opening, and
a tool (18) which reaches through at least one opening of each patch (26, 36, 40) is used for guiding through the inner patch (36).

4. The method according to claim 3, characterized in that the tool (18) is used to press the inner patch (36) against the aircraft component (10) during the adhesive bonding.

5. The method according to claim 1, characterized by the steps of:
ascertaining a damage site location of the damage site (12),
determining a contour of the aircraft component in an area around the damage site (12) and
creating the patches (26, 36, 40) in such a way that they follow the contour of the aircraft component.

6. The method according to claim 5, characterized in that the determination of the contour of the aircraft component comprises scanning and/or taking an impression of the surface contour.

7. The method according to claim 5, characterized in that the determination of the contour of the aircraft component comprises retrieving the surface contour from a databank on the basis of the damage site location.

8. A method for producing a patch (26, 36, 40) for use with a method according to one of the preceding claims comprising the steps of:
laying CRP prepregs (58) of various dimensions one on top of the other,
adhesively bonding the CRP prepregs (58) by heating,
impregnating the CRP prepregs (58) with resin, and
curing the impregnated CRP prepregs (58), so that at least one patch (26, 36, 40) is produced.

9. The method according to claim 8, characterized in that the CRP prepregs (58) are fiber mats (58) and in that the fiber mats (58) are laid one on top of the other in such a way that the directions of their fibers correspond to the directions of the fibers of the aircraft component (10) to be repaired.

10. The method according to claim 9, characterized in that the fiber mats (58) are laid one on top of the other in a stack (60) in such a way that the stack (60) has a convex inward curving (62) at a periphery and, during the adhesive bonding, at least two fiber mats (58) that are not neighboring are bonded together.

11. The method according to claim 8, characterized in that the curing comprises the following steps:
introducing the stack (60) into a curing mold which corresponds to the contour of the aircraft component, and
curing the stack (60), so that the patch is produced.

12. The method according to claim 8, characterized in that all the patches (26, 36, 40) are cured at the same time and in a common device.

13. A patch kit (26, 36, 40) for carrying out a method according to one of the preceding claims, comprising a middle patch (26), an inner patch (36), which is larger than the middle patch (26), and an outer patch (40), which is larger than the middle patch (26), the patches (26, 36, 40) having openings which are arranged in such a way that, when the hole (14) is closed with the patches (26, 36, 40), the openings form a through-opening.

14. The patch kit according to claim 13, characterized in that the patch kit (26, 36, 40) further comprises a tool (18), which is formed for carrying out a method according to one of claims 1 to 12.

15. The method according to claim 1, characterized by the steps of:
producing an inner patch and a middle patch (26, 36), the creation of the patches comprising the steps of:
laying CRP prepregs (58) of various dimensions one on top of the other,
adhesively bonding the CRP prepregs (58) by heating,
impregnating the CRP prepregs (58) with resin, and
curing the impregnated CRP prepregs (58), so that at least one patch (26, 36, 40) is produced.

16. The method according to claim 15, characterized in that the CRP prepregs (58) are fiber mats (58) and in that the fiber mats (58) are laid one on top of the other in such a way that the directions of their fibers correspond to the directions of the fibers of the aircraft component (10) to be repaired.

17. The method according to claim 16, characterized in that the fiber mats (58) are laid one on top of the other in a stack (60) in such a way that the stack (60) has a convex inward curving (62) at a periphery and, during the adhesive bonding, at least two fiber mats (58) that are not neighboring are bonded together.

18. The method according to claim 15, characterized in that the curing comprises the following steps:
introducing the stack (60) into a curing mold which corresponds to the contour of the aircraft component, and
curing the stack (60), so that the patch is produced.

19. The method according to claim 15, characterized in that all the patches (26, 36, 40) are cured at the same time and in a common device.

20. The method according to claim 2, characterized by the steps of:
producing an outer patch (40), the creation of the patch comprising the steps of:
laying CRP prepregs (58) of various dimensions one on top of the other,
adhesively bonding the CRP prepregs (58) by heating,
impregnating the CRP prepregs (58) with resin, and
curing the impregnated CRP prepregs (58), so that at least one patch (26, 36, 40) is produced.
